(19) United States
(12) Patent Application Publication
(10) Pub. No.: US 2003/0229851 A1
(43) Pub. Date: Dec. 11, 2003

(54) Defining layout files by markup language documents

(76) Inventors: Heinz Willumeit, St. Leon-Rot (DE); Jorg Bischof, Muhlhausen (DE)

Correspondence Address: FINNEGAN, HENDERSON, FARABOW, GARRETT & DUNNER, LLP, 1300 I STREET, NW, WASHINGTON, DC, 20005, US

(21) Appl. No.: 10/275,395

(22) PCT Filed: Jun. 11, 2002
(86) PCT No.: PCT/EP02/06388

(51) Int. Cl. G06F 15/00

(52) U.S. Cl. 715/513; 715/517

(57) ABSTRACT

In a computer system for displaying a content page (250) on first and second computers (901, 902), layouts are defined in a first layout file (251) and a second layout file (252). The first and second layout files (251, 252) each are provided by a parser that reads a first markup language document and a second markup language document, respectively. Each markup language document has a first entity and a second entity in that instructions define portions of the respective layout file (251/252) by predefined information added to the respective layout file (251/252) and by parameterized values also added to the respective layout file (251/252). The parameterized values are valid for both the first entity and the second entity.

### FIELD OF THE INVENTION

The present invention generally relates to computer networks, and, more particularly, relates to system, method and computer program for providing layout files for HTML-pages.

### BACKGROUND OF THE INVENTION

Companies or other organizations use predefined presentation layouts (a) for written documents such as letters, facsimile, or advertisement papers, as well as (b) for display presentations in electronic media such as in internet pages, intranet pages, television commercials, etc.

Each layout is defined, for example, by certain colors, by one or more logos, by a letter font size. The layouts are defined in layout files that are distributed throughout the organization. Changes in the layout have to be made in all files. It is not desired to leave some files out. For example, an organization that uses blue as the color of choice for its name, might get undesired attention from the general public if some of its presentations show the same name in red color.

However, customizing the presentation layout requires efforts; adapting the layout requires changing a plurality of items in the layout files.

It is desired to always use the right layout; there is an ongoing need to provide centralized layout management.

### SUMMARY OF THE INVENTION

According to a method the present invention, a layout file determines the visual layout of a browser presentation of a content page, the layout file is determined by the following steps: providing a markup language document, the document having a plurality of entities with instructions to define portions of the layout file, and for each entity of the markup language document, executing the instructions to add to the layout file predefined information of the instruction and to add a parameterized value of the instruction, wherein the parameterized value is valid for at least a first entity and a second entity of the plurality of entities.

Preferably, in the step providing the markup language document, the document is provided in XML. It is an advantage of the present invention that the validity of the parameterized value applies for first and second entities, all changes to the parameterized value are automatically updated into the layout file.

The present invention also relates to a computer program product having a plurality of processor commands for causing a first computer to provide a layout file, the layout file determining the visual layout of a browser presentation of a content page in a second computer, the plurality of processor commands causing the first computer to: provide a markup language document with a plurality of entities in that instructions define portions of the layout file, and to execute the instructions for each entity of the markup language document, wherein predefined information of the instruction is added to the layout file, wherein a parameterized value of the instruction is added to the layout file, the parameterized value being valid for at least a first entity and a second entity of the plurality of entities.

The present invention also relates to an article of manufacture with computer readable medium having computer readable program code means embodied therein for providing a layout file, the layout file determining the visual layout of a browser presentation of a content page, the program code means causing to provide a markup language document with a plurality of entities in that instructions define portions of the layout file, and to execute the instructions for each entity of the markup language document, wherein predefined information of the instruction is added to the layout file, wherein a parameterized value of the instruction is added to the layout file, the parameterized value being valid for at least a first entity and a second entity of the plurality of entities.

The present invention also relates to a computer system for displaying a content page on a first computer and on a second computer, the content page being provided by a content provider computer; the first computer displaying the content page according to a first layout defined in a first layout file and the second computer displaying the content page according to a second layout defined in a second layout file, the first layout file and the second layout file each being provided by a parser that reads a first markup language document and a second markup language document, respectively. Each markup language document has a first entity and a second entity, in each entity instructions define portions of the respective layout file by predefined information added to the respective layout file and by parameterized values added to the respective layout file. The parameterized values are valid for both the first entity and the second entity.

### BRIEF DESCRIPTION OF THE DRAWINGS

FIG. 1 illustrates a simplified block diagram of a computer network system having a plurality of computers;

FIG. 2 illustrates a simplified block diagram of a network system in that the present invention is applied;

FIG. 3 illustrates a group and a tray, each with a title in a first organization on a first computer;

FIG. 4 illustrates a group and a tray, each with a title in a second organization on a second computer;

FIG. 5 illustrates simplified block diagrams of a markup language document, a parser, and a layout file according to the present invention;

FIG. 6 illustrates a simplified code listing of a markup language document;

FIG. 7 illustrates a simplified method flow chart diagram of a method of the present invention;

FIG. 8 illustrates a more detailed flow chart diagram of the second method step;

FIG. 9 illustrates a more detailed flow chart diagram of a recursive method step.

### DETAILED DESCRIPTION OF THE INVENTION

For convenience, a list of references is provided prior to the claims. As used herein, when referring to coding, each code line is numbered in parenthesis.

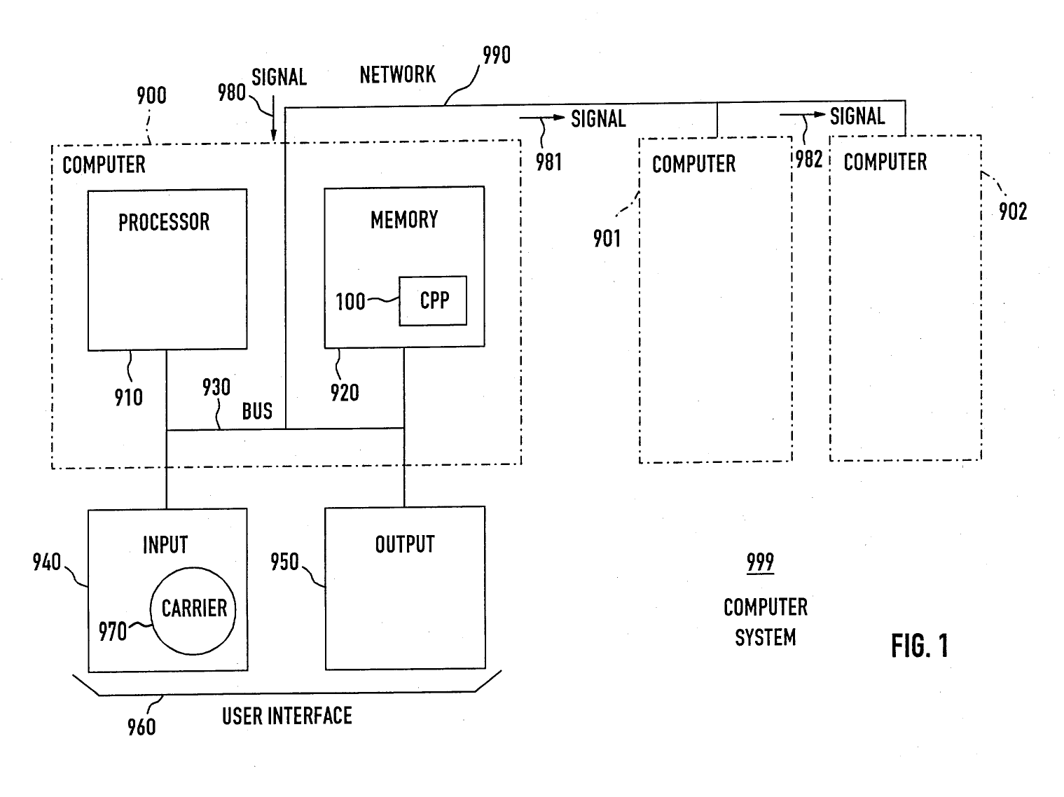

FIG. 1 illustrates a simplified block diagram of computer network system 999 having a plurality of computers 900, 901, 902 (or 90q, with q=0 . . . Q−1, Q any number).

Computers 900-902 are coupled via inter-computer network 990. Computer 900 comprises processor 910, memory 920, bus 930, and, optionally, input device 940 and output device 950 (I/O devices, user interface 960). As illustrated, the invention is present by computer program product 100 (CPP), program carrier 970 and program signal 980, collectively “program”.

In respect to computer 900, computer 901/902 is sometimes referred to as “remote computer”, computer 901/902 is, for example, a server, a router, a peer device or other common network node, and typically comprises many or all of the elements described relative to computer 900. Hence, elements 100 and 910-980 in computer 900 collectively illustrate also corresponding elements 10q and 91q-98q (shown for q=0) in computers 90q.

Computer 900 is, for example, a conventional personal computer (PC), a desktop and hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer or the like.

Processor 910 is, for example, a central processing unit (CPU), a micro-controller unit (MCU), digital signal processor (DSP), or the like.

Memory 920 symbolizes elements that temporarily or permanently store data and instructions. Although memory 920 is conveniently illustrated as part of computer 900, memory function can also be implemented in network 990, in computers 901/902 and in processor 910 itself (e.g., cache, register), or elsewhere. Memory 920 can be a read only memory (ROM), a random access memory (RAM), or a memory with other access options. Memory 920 is physically implemented by computer-readable media, such as, for example: (a) magnetic media, like a hard disk, a floppy disk, or other magnetic disk, a tape, a cassette tape; (b) optical media, like optical disk (CD-ROM, digital versatile disk—DVD); (c) semiconductor media, like DRAM, SRAM, EPROM, EEPROM, memory stick, or by any other media, like paper.

Optionally, memory 920 is distributed across different media. Portions of memory 920 can be removable or non-removable. For reading from media and for writing in media, computer 900 uses devices well known in the art such as, for example, disk drives, tape drives. Memory 920 stores support modules such as, for example, a basic input output system (BIOS), an operating system (OS), a program library, a compiler, an interpreter, and a text-processing tool. Support modules are commercially available and can be installed on computer 900 by those of skill in the art. For simplicity, these modules are not illustrated.

CPP 100 comprises program instructions and—optionally—data that cause processor 910 to execute method steps of the present invention. Method steps are explained with more detail below. In other words, CPP 100 defines the operation of computer 900 and its interaction in network system 999. For example and without the intention to be limiting, CPP 100 can be available as source code in any programming language, and as object code (“binary code”) in a compiled form. Persons of skill in the art can use CPP 100 in connection with any of the above support modules (e.g., compiler, interpreter, operating system).

Although CPP 100 is illustrated as being stored in memory 920, CPP 100 can be located elsewhere. CPP 100 can also be embodied in carrier 970.

Carrier 970 is illustrated outside computer 900. For communicating CPP 100 to computer 900, carrier 970 is conveniently inserted into input device 940. Carrier 970 is implemented as any computer readable medium, such as a medium largely explained above (cf. memory 920). Generally, carrier 970 is an article of manufacture comprising a computer readable medium having computer readable program code means embodied therein for executing the method of the present invention. Further, program signal 980 can also embody computer program 100. Signal 980 travels on network 990 to computer 900.

Having described CPP 100, program carrier 970, and program signal 980 in connection with computer 900 is convenient. Optionally, program carrier 971/972 (not shown) and program signal 981/982 embody computer program product (CPP) 101/102 to be executed by processor 911/912 (not shown) in computers 901/902, respectively.

Input device 940 symbolizes a device that provides data and instructions for processing by computer 900. For example, device 940 is a keyboard, a pointing device (e.g., mouse, trackball, cursor direction keys), microphone, joystick, game pad, scanner. Although the examples are devices with human interaction, device 940 can also operate without human interaction, such as, a wireless receiver (e.g., with satellite dish or terrestrial antenna), a sensor (e.g., a thermometer), a counter (e.g., goods counter in a factory). Input device 940 can serve to read carrier 970.

Output device 950 symbolizes a device that presents instructions and data that have been processed. For example, a monitor or a display, (cathode ray tube (CRT), flat panel display, liquid crystal display (LCD), speaker, printer, plotter, vibration alert device. Similar as above, output device 950 communicates with the user, but it can also communicate with further computers.

Input device 940 and output device 950 can be combined to a single device; any device 940 and 950 can be provided optional.

Bus 930 and network 990 provide logical and physical connections by conveying instruction and data signals. While connections inside computer 900 are conveniently referred to as “bus 930”, connections between computers 900-902 are referred to as “network 990”. Optionally, network 990 comprises gateways being computers that specialize in data transmission and protocol conversion.

Devices 940 and 950 are coupled to computer 900 by bus 930 (as illustrated) or by network 990 (optional). While the signals inside computer 900 are mostly electrical signals, the signals in network are electrical, magnetic, optical or wireless (radio) signals.

Networking environments (as network 990) are commonplace in offices, enterprise-wide computer networks, intranets and the internet (i.e. world wide web). The physical distance between a remote computer and computer 900 is not important. Network 990 can be a wired or a wireless network. To name a few network implementations, network 990 is, for example, a local area network (LAN), a wide area network (WAN), a public switched telephone network (PSTN); a Integrated Services Digital Network (ISDN), an infra-red (IR) link, a radio link, like Universal Mobile Telecommunications System (UMTS), Global System for Mobile Communication (GSM), Code Division Multiple Access (CDMA), or satellite link.

Transmission protocols and data formats are known, for example, as transmission control protocol/internet protocol (TCP/IP), hyper text transfer protocol (HTTP), secure HTTP, wireless application protocol, unique resource locator (URL), a unique resource identifier (URI), hyper text markup language HTML, extensible markup language (XML), extensible hyper text markup language (XHTML), wireless application markup language (WML), etc.

Interfaces coupled between the elements are also well known in the art. For simplicity, interfaces are not illustrated. An interface can be, for example, a serial port interface, a parallel port interface, a game port, a universal serial bus (USB) interface, an internal or external modem, a video adapter, or a sound card.

Computer and program are closely related. As used hereinafter, phrases, such as “the computer provides” and “the program provides”, are convenient abbreviation to express actions by a computer that is controlled by a program.

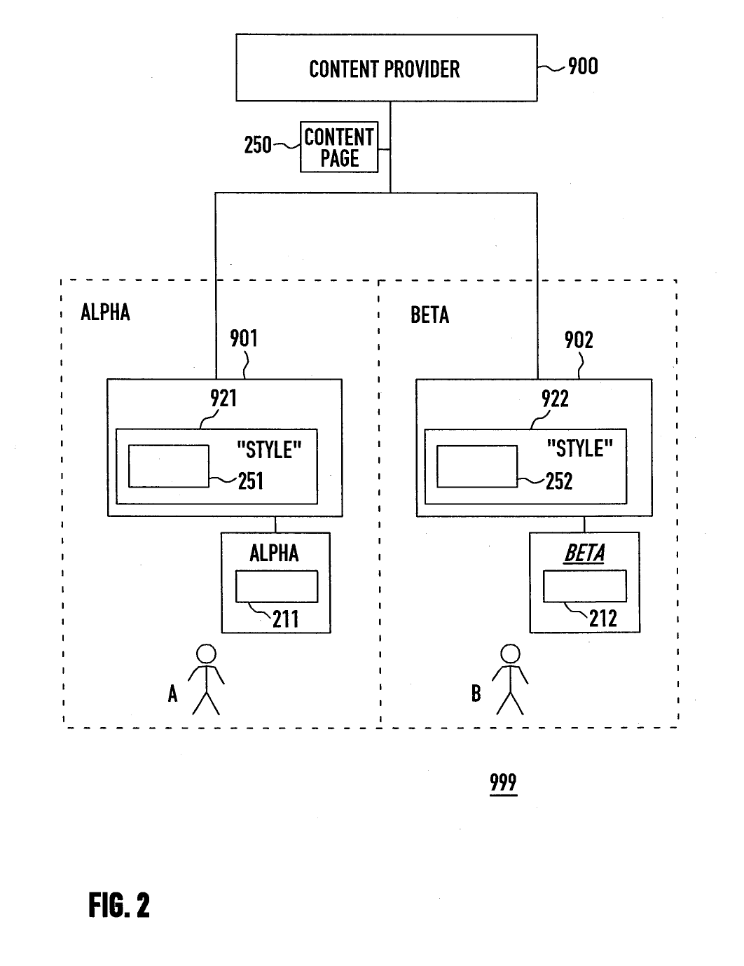

FIG. 2 illustrates a simplified block diagram of network system 999 in that the present invention is applied. User A operates first computer 901; user B operates second computer 902. Each computer 901/902 has a browser that causes display 951/952 to display HTML-pages. Browsers are commercially available and well known in the art.

User A and user B work in different organizations (dashed frames): organization ALPHA uses a first organization presentation layout and organization BETA uses a second presentation layout. As mentioned above, each layout is defined, for example, by color, logo, font, and font size, etc. For example, in written documents, or in display presentations (e.g. internet homepage), display 951 of computer 901 displays “ALPHA” in plain letters; display 952 of computer 902 displays “BETA” in italics und underlined.

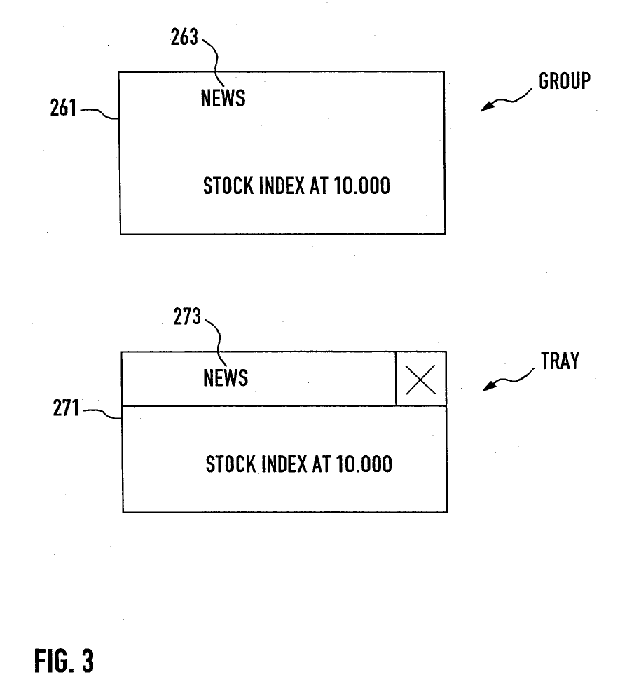

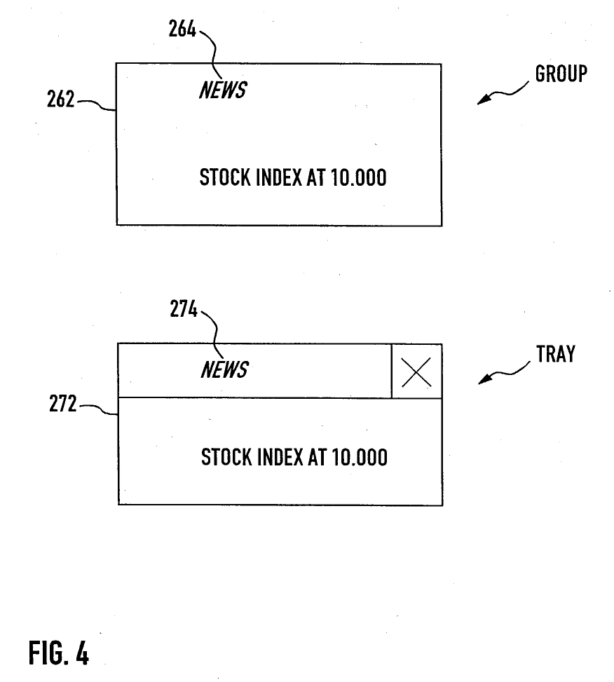

Both computers 901/902 display identical content, for example, business news, whether news, as indicated by content boxes 211, 212 in displays 951 and 952, respectively. As used herein, the exemplary content is “stock index at 10.000”. Content boxes are further detailed later. For example, content boxes are implemented by predefined layout items such as “groups” or “trays” (cf. FIGS. 3-4).

Content is provided by content provider computer 900. Computer 900 sends content page 250 to computers 901/902. Illustrating computer 900 as a single computer that sends pages to both computers 901/902 is convenient for explanation, but not necessary for the present invention. Separate content provider computers can be implemented in both ALPHA and BETA organizations. Computer 900 generates page 250 automatically or in interaction with a human operator (not shown). Preferably, page 250 is provided in HTML or in other markup language such as WML or XML.

Preferably, page 250 comprises content only; it is understood that content provider computer 900 consecutively provides new and updated content pages.

Layout file 251 is available to computer 901; layout file 252 is available to computer 902. For example, files 251 and 252 are stored in memories 921 and 922 of computers 901 and 902, respectively, or stored elsewhere. Conveniently, layout files 251 and 252 have the same file name, for example, “STYLE”. The creation of files 251 and 252 according to the present invention is explained in connection with FIGS. 3-7.

Layout files 251 and 252 both are referenced from page 250. For example, in the header portion of HTML-page 250, layout file “STYLE” is defined as a link in a predefined type (here: CSS-type)

(1)<head>

(2)<link href=“style” type=“css”>

(3)</head>

The type CSS (“cascading style sheet”) is a predefined type that contains formatting and layout information.

CSS is defined by the World Wide Web Consortium (W3C, “www.w3.org/”) in the following specifications:

“Cascading Style Sheets, level 1, W3C Recommendation, Dec 17, 1996, revised Jan 11, 1999” and “Cascading Style Sheets, level 2, W3C Recommendation, May 12, 1998”.

Sharing the file name “STYLE” for files 251 and 252 does not create a conflict between computers 901 and 902 because different computers 901/902 in different organizations ALPHA and BETA use different file location domains and paths. Hence, both assignments of file 251 to computer 901 and of file 252 to computer 902 are unique.

The body portion of page 250 comprises the actual content; that is:

(4) <body>
(5) <div>
(6) <div class=“GroupTitle”>News</div>
(7) <div class=“GroupBody”>

Stock Index today at 10.000</div>

(8) </div>
(9) </body>

The tag “div” in line (6) points to a class (here called “GroupTitle”) that is defined in files 251 and 252. According to the present invention, when content page 250 is displayed in computer 901 then the class “GroupTitle” is taken from file 251; when content page 250 is displayed in computer 902 then the class “GroupTitle” is taken from file 252.

In the example, the title (“News”) is displayed in a predefined layout item “group”. In the alternative, with modified coding in page 250, the title is displayed in the layout item “tray”. Examples for “group” and “tray” are illustrated in connection with FIGS. 3-4.

For the following discussion how class “GroupTitle” is defined in files 251/252, only layout file 251 discussed; layout file 252 is provided in a similar manner or is provided traditionally as known in the art.

FIG. 3 illustrates group 261 and tray 271 each with title 263 and 273, respectively (“NEWS”), in organization ALPHA on computer 901.

It is desired to display titles 263 and 273 in plain text (“NEWS”). Group 261 and tray 271 are examples for a type of display items.

FIG. 3 also shows content (“STOCK . . . ”); the choice whether to display group or tray depends on the entry in content page 250 (lines 6, 7, group). Tray and group distinguish by their visual appearance; 271 has a close button (right upper corner).

FIG. 4 illustrates group 262 and tray 272 each with title 264 and 274, respectively (“NEWS”) in organization BETA on computer 902. It is desired to write titles 264 and 274 in underlined italics text (“NEWS”). Group 262 and tray 272 are examples for a type of display items. FIG. 4 also shows content (“STOCK . . . ”); again, the choice whether to display group or tray depends on the entry in content page 250 (lines 6, 7, “group”).

The following explains how layout files 251 and 252 are coded. Preferably, file 251 has the following coding:

(1) GroupTitle {
(2) font-family: Arial;
(3) font-style: normal;
(4) }
(5) TrayTitle {
(6) font-family: Arial;
(7) font-style: normal;
(8) }

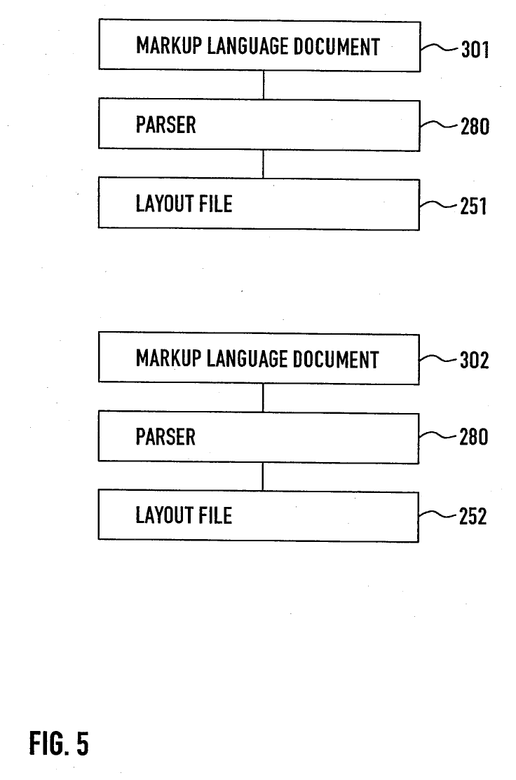

That means that the browser is instructed to show titles 263/273 in both groups 261 and 271 by normal Arial font; it is an advantage of the present invention that the layout definitions is written into lines (2),(3),(6), and (7) of file 251 by a single markup language document 301 (FIGS. 5-7).

Similar rules apply for the coding of file 252, that is:

(1) GroupTitle {
(2) font-family: Arial;
(3) font-style: italics, underline;
(4) }
(5) TrayTitle {
(6) font-family: Arial;
(7) font-style: italics, underline;
(8) }

That means that the browser is instructed to show titles 264/274 in both group 262 and 272 by italics underlined Arial font; it is an advantage of the present invention that these layout definitions in written into file 252 by single document 302. In other words, layout files 251 and 252 each have pluralities of layout classes, each class for a type of display items, for example “group” and “try”.

FIG. 5 illustrates simplified block diagrams of a markup language document, a parser, and a layout file according to the present invention. For customizing the layout for ALPHA, parser 280 reads document 301 and provides file 251; similarly, for customizing the layout for BETA, parser 280 reads document 302 and provides file 252. It is an advantage that for adapting files 251 and 252 to organization layouts, all classes (e.g. for groups and trays) are adapted.

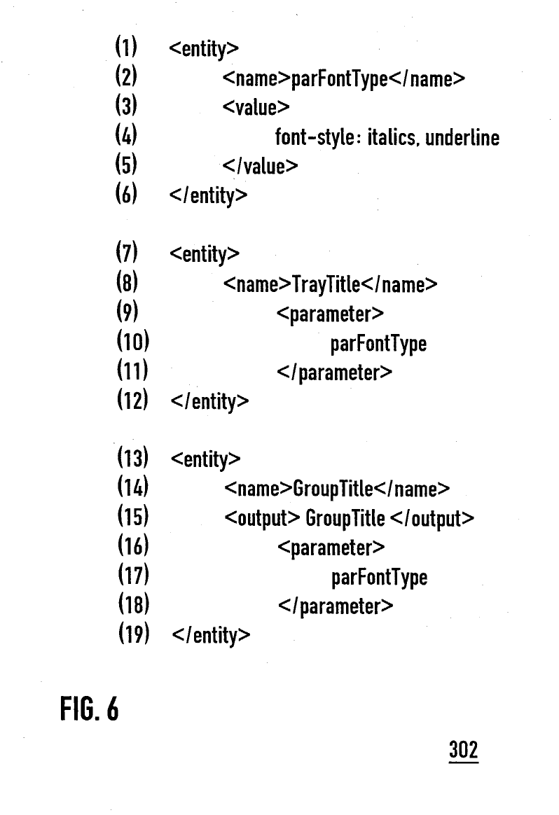

FIG. 6 illustrates a simplified code listing of markup language document 302 (BETA). Markup language document 302 is, preferably, written in XML. Entities are defined for a first entity (lines 1-6), a second entity (lines 7-12), a third entity (lines 13-19). Line (4) (“parFontType”) introduces a single parameter that is used to define the title layout (cf. titles 264, 274 in FIG. 4). The value of the parameter is “italics, underline”, cf. line (10). Lines (14)-(15) indicate that actually file 252 is created (GroupTitle). For convenience, further definitions (e.g., of Arial as the font) are not illustrated. The explanation for document 302 is also valid for document 301. For organization ALPHA, document 301, line (17), would read “normal”, parser 280 would read 301 and would provide 251 (“STYLE”), cf. FIG. 5. It is an advantage that only a single parameter (i.e. in line 17) has to be changed. For convenience of explanation, document 301/302 is written for a single-pass parser, so that the parameter defining entity (i.e. lines 1-6) comes first; persons of skill in the art can also write document 301/302 for a multi-pass parser with a modified entity order.

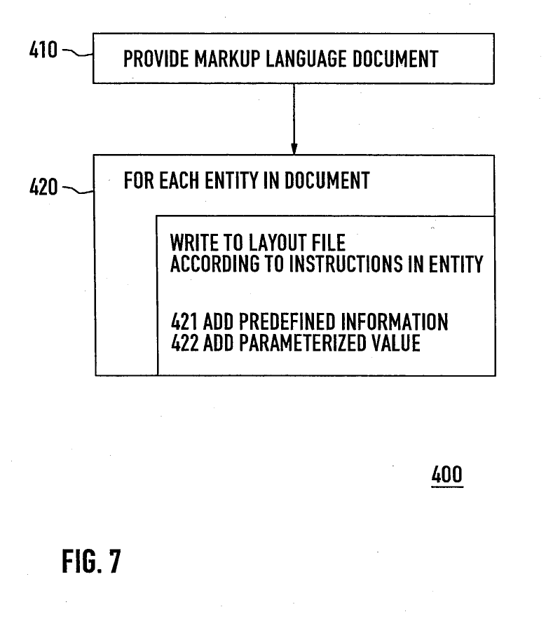

FIG. 7 illustrates a simplified method flow chart diagram of a method of the present invention. Method 400 for providing layout file 251/252 that determines the visual layout (cf. FIG. 1, on display 951/952) of a browser presentation of content page 250 comprises the steps providing 410 markup language document 301/302, and executing 420 instructions to add 421 predefined information and to add 422 a parameterized value. In step providing 410, document 301/302 is provided with a plurality of entities, cf. FIG. 6, lines 1-6, lines 7-12, and lines 13-19. Some or all entities have instructions (e.g., line 15, instruction “output”) to define portions of layout file 251/252, for example, in lines 1, 3, 6, 7 of file 251/252.

In step executing 420 the instructions for each entity (e.g., 1-6, 7-12, 13-19 of document 302) of markup language document 301/302, parser 280 adds 421 to layout file 251/252 predefined information (e.g., “GroupTitle”, line 15) of the instruction and adds 422 a parameterized value (e.g., “italics, underline”, line 4) of the instruction. The parameterized value is valid for at least a first entity (e.g. lines 7-12) and a second entity (e.g., lines 13-19) of the plurality of entities of document 301/302. Preferably, in step providing 410, markup language document 301/302 is provided in XML.

Performing method 400 in content provider computer 900 is convenient, but not necessary for the present invention. Method 400 can be performed on any other standard computer. For simplicity of explanation, performing method 400 in computer 900 is assumed. The present invention is also described as computer program product 100 (CPP) having a plurality of processor commands for causing “first” computer 900 to provide layout file 251/252. As explained above, layout file 251/252 determines the visual layout of a browser presentation (for example, on display 951/952) of content page 250 in “second” computer 901/902. The plurality of processor commands cause computer 900 to:

provide (cf. step 410) markup language document 301/302 with a plurality of entities (for example 1-6, 7-12, 13-19) in that instructions define portions of the layout file (e.g., instruction “output”),

execute (cf. step 420) the instructions for each entity of the markup language document, wherein predefined information of the instruction is added (cf. step 421) to layout file 251/252, wherein a parameterized value of the instruction is added to layout file 251/252. The parameterized value is valid for at least a first entity (e.g., on lines 7-12) and a second entity (e.g., on lines 13-19) of the plurality of entities.

In other words, the present invention applied to computer system 999 is summarized as follows: Displayed is content page 250 on first computer 901 and on second computer 902, content page 250 is provided by content provider computer 900; first computer 901 displays content page 250 according to a first layout defined in first layout file 251, and second computer 902 displays content page 250 according to a second layout defined in second layout file 252. First layout file 251 and second layout file 252 each are provided by parser 280 that reads first markup language document 301 and second markup language document 302, respectively. Each markup language document 301/302 has a first entity 7-12 and a second entity 13-19 in that instructions define portions of the respective layout file 251/252 by predefined information added 421 to the respective layout file 251/252 and by parameterized values also added to the respective layout file 251/252. The parameterized values are valid for both the first entity 7-12 and the second entity 13-19. Validity in both entities ensures that display items are unique for each layout file.

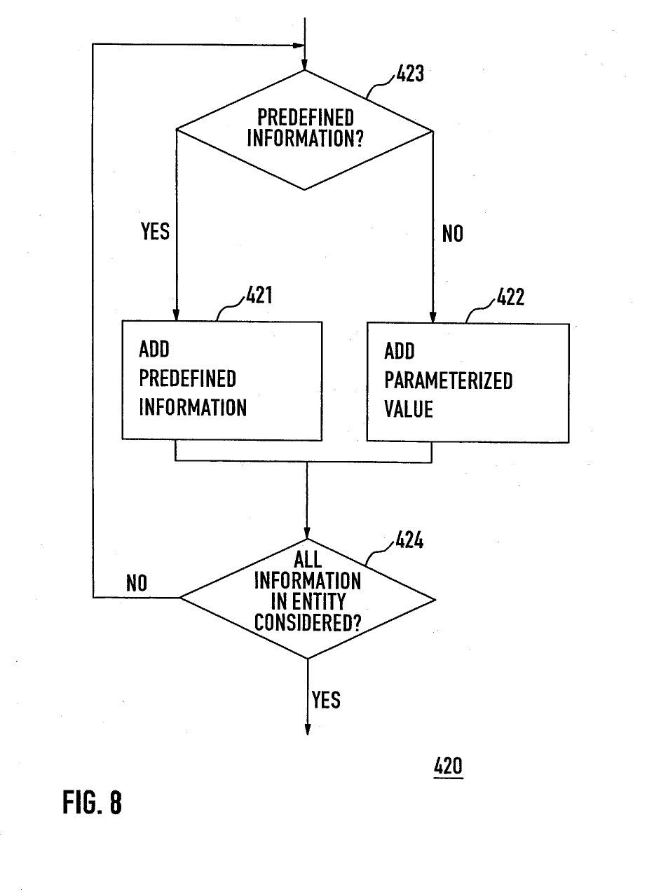

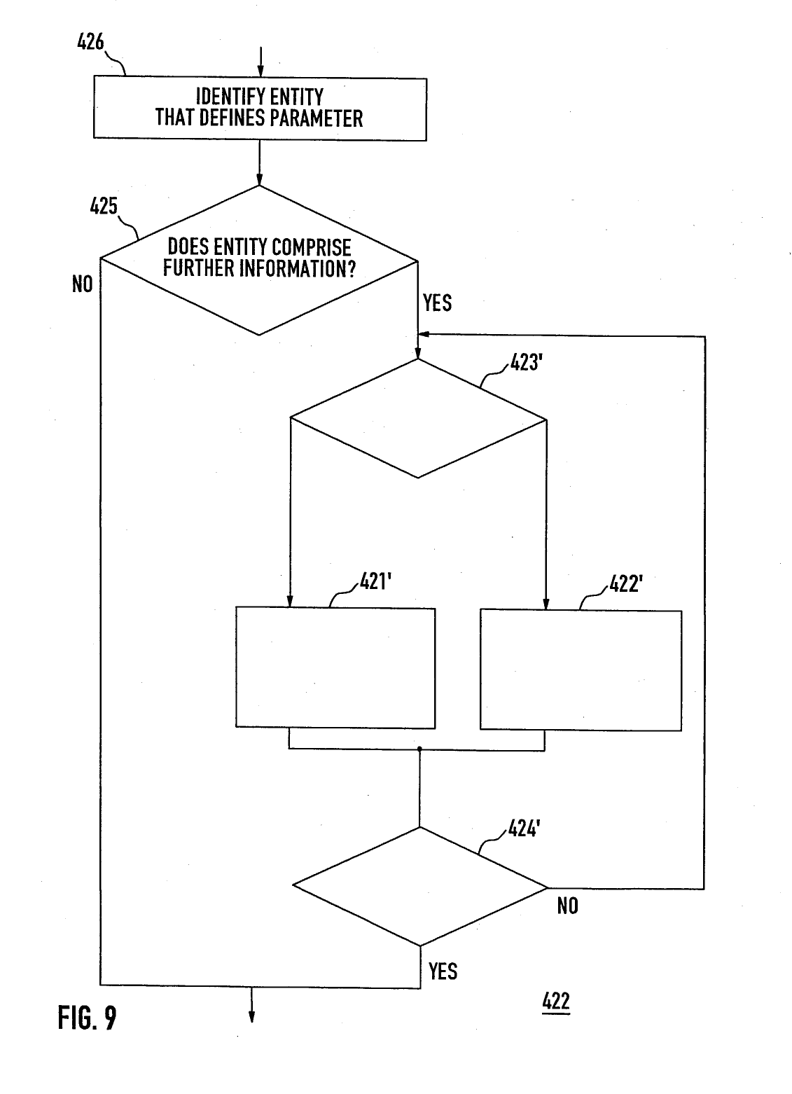

FIG. 8 illustrates a more detailed flow chart diagram of second method step 420. First, sub-step 423, parser 280 checks the existence of predefined information in the entity (YES/NO). In the example of document 302 in FIG. 6, predefined information is the information identified by the tags <value> and <output>. Predefined information is: “font-style: italics, underline” in entity 1-6 and “GroupTitle” in entity 13-19. Second, if predefined information is existent (YES), parser 280 adds the predefined information to layout file 251/252 in sub-step 421; otherwise (NO) parser adds the parameterized value as in step 422 (details in FIG. 9).

Step 420 continues with a conditional repetition of sub-steps 421/422 for further information (query 424).

FIG. 9 illustrates a more detailed flow chart diagram of method step 422. As mentioned, step 422 adds the parameterized value. Step 422 is—optionally—recursive: in FIG. 9, prime-marked sub-steps 421′, 422′, 423′, 424′ correspond to the sub-steps in FIG. 8. In step 426, parser 280 identifies the entry that defines the parameter. For example, step 420 is called for entity 13-19 of document 302 (parameter “parFontType”); sub-step 426 identifies entity 1-6 as defining “parFontType”. If the identified entity (e.g., 1-6) comprises further information (query 425 YES), parser 280 executes steps 423′, 421′, 422′ and 424′ as described in connection with FIG. 8. For example, the further information in entity 1-6 is the font-style definition in line 4 that is written (add 421′) to layout file 252.

List of References

100 CPP

1-6, 7-12, 13-19 entities

211/212 content boxes

250 content page

251 layout file

252 layout file

261 group (for ALPHA)

262 group (for BETA)

263/273 title (for ALPHA)

264/274 title (for BETA)

271 tray (for ALPHA)

272 tray (for BETA)

280 parser

301/302 markup language document

400 method

410 providing

420 executing instruction

421/422 adding

900 content provider computer

901 first computer, ALPHA

902 second computer, BETA

910 processor

920/921/922 memory

940 input

950/951/952 output (display)

960 user interface

970 carrier

981/982 signal

990 network

999 computer system

1. A method (400) for providing a layout file (251/252), the layout file determining the visual layout of a browser presentation of a content page (250), the method (400) comprising the following steps:
providing (410) a markup language document (301/302), the document having a plurality of entities with instructions to define portions of the layout file (251/252),
for each entity of the markup language document, executing (420) the instructions to add (421) to the layout file (251/252) predefined information of the instruction and to add (421) a parameterized value of the instruction, wherein the parameterized value is valid for at least a first entity (7-12) and a second entity (13-19) of the plurality of entities.

2. The method (400) of claim 1, wherein in the step providing (410) the markup language document (301/302), the document is provided in XML.

3. Computer program product (100) having a plurality of processor commands for causing a first computer (901) to provide a layout file (251/252), the layout file determining the visual layout of a browser presentation of a content page (250) in a second computer (902), the plurality of processor commands causing the first computer (901) to:
provide (410) a markup language document (301/302) with a plurality of entities in that instructions define portions of the layout file (251/252), and
execute (420) the instructions for each entity of the markup language document (301/302), wherein predefined information of the instruction is added (421) to the layout file, wherein a parameterized value of the instruction is added (422) to the layout file, the parameterized value being valid for at least a first entity (7-12) and a second entity (13-19) of the plurality of entities.

4. Article of manufacture (970) with computer readable medium having computer readable program code means embodied therein for providing a layout file (251/252), the layout file determining the visual layout of a browser presentation of a content page (250), the program code means causing to provide (410) a markup language document (301/302) with a plurality of entities in that instructions define portions of the layout file, and to execute (420) the instructions for each entity of the markup language document, wherein predefined information of the instruction is added (421) to the layout file, wherein a parameterized value of the instruction is added (422) to the layout file, the parameterized value being valid for at least a first entity and a second entity of the plurality of entities.

5. Computer system (999) for displaying a content page (250) on a first computer (901) and on a second computer (902), the content page (250) being provided by a content provider computer; the first computer (901) displaying the content page (250) according to a first layout defined in a first layout file (251) and the second computer (902) displaying the content page (250) according to a second layout defined in a second layout file (252), the first layout file (251) and the second layout file (252) each being provided by a parser that reads a first markup language document (301) and a second markup language (302) document respectively, each markup language document (301/302) having a first entity and a second entity in that instructions define portions of the respective layout file by predefined information added (421) to the respective layout file (251/252) and by parameterized values added (422) to the respective layout file (251/252), the parameterized values being valid for both the first entity and the second entity.
